(19) United States
(12) Patent Application Publication
(10) Pub. No.: US 2013/0187320 A1
(43) Pub. Date: Jul. 25, 2013

(54) SHOCK ABSORPTION MOUNT HAVING A HOUSING WITH A CONTOURED INNER SURFACE

(71) Applicant: Jan HENSELMEYER, Hasbergen (DE)

(72) Inventor: Jan HENSELMEYER, Hasbergen (DE)

(73) Assignee: BASF SE, Ludwigshafen (DE)

(21) Appl. No.: 13/358,198

(22) Filed: Jan. 25, 2012

(51) Int. Cl. B60G 11/22; F16F 7/00

(52) U.S. Cl. 267/292

(57) ABSTRACT

A damper bearing comprising a hollow housing (10) for accommodating a damping element (20) and also a cover (30) for fixing the damping element (20) in the housing (10), the housing having a housing base (12) with a bore, wherein the inner surface of the housing base, the inner surface of the cover or both inner surfaces have contouring formed by elevations and depressions.

### BACKGROUND

Damper bearings are used in automobiles within the chassis and are well known. They are used in particular in motor vehicles as vibration-damping components. In the process, they attach the shock absorber to the bodywork and/or to components of the chassis. By way of such elastic coupling, vibrations which are brought about by the roadway and are passed on via the wheel and the shock absorber, and also vibrations which are brought about by the shock absorber, are isolated. The coupling is configured such that cardanic movements of the shock absorber are made possible and the requirements as to force/travel characteristics are fulfilled in the axial, radial and cardanic directions. Depending on the chassis design, axial and radial characteristics have a substantial influence on the driving behavior and must be matched exactly. The interaction of the shock absorber and damper bearing has a decisive influence on driving comfort, driving safety, roll and pitch support and also the reduction of effects of wheel jolt and body tremble.

Various types of damper bearings are known. Thus, the Offenlegungsschrift DE 10 2007 003 207 A1 describes for example a damper bearing having a housing, a bearing element and a cover, wherein the bearing element is fixed in the housing by the cover. By way of an insert in the bearing element, the shock absorber can be fastened elastically to the damping element. The damping element in turn is attached to the bodywork of a motor vehicle. Also known, however, are damper bearings in the case of which the bodywork forms the cover so that the damper bearing is connected directly to the bodywork of the motor vehicle via its housing.

In recent years, it has been found that the damping properties of damper bearings can be improved when damping elements are contoured in the axial and/or in the radial direction. Such a damping element is disclosed for example in the Offenlegungsschrift DE 10 2005 009 667 A1. A contoured lateral surface brings about smoother compression in the radial direction, whereas elevations on the end faces of the damping element improve the suspension behavior in the axial direction. In addition, contouring brings about a constant stiffness profile.

### SUMMARY

However, damper bearings having known damping elements have the disadvantage that the contoured damping elements are complicated to manufacture and are therefore expensive.

It is an object of the invention to provide damper bearings which are easy to manufacture and cost-effective to produce. At the same time, the advantageous properties of known damper bearings with regard to driving comfort and safety should remain ensured.

This object is achieved by damper bearings according to the invention. Damper bearings according to the invention comprise a hollow housing having a housing base which has a bore. The upper end of a piston rod of a shock absorber is usually guided through the bore in the installed state. Furthermore, the damper bearing has a cover which is suitable for fixing a damping element located within the housing. According to the invention, the inner surface of the housing base, the inner surface of the cover or both inner surfaces have contouring formed by elevations and depressions.

In preferred configurations, the housing is substantially cylindrical, the expression “substantially cylindrical” being understood to mean housings, the inside diameter of which changes by no more than 10%, in particular by no more than 5%, in the direction of the cylinder axis.

In a preferred embodiment, both the inner surface of the housing base and the inner surface of the cover have contouring.

In preferred embodiments of the damper bearing according to the invention, the maximum height difference between an elevation and a depression of the contouring is from 1.5 mm to 5 mm. Particularly preferably, the maximum height difference is from 2 mm to 4 mm. The maximum height difference is understood according to the invention to be the greatest value of the distance between an elevation and a depression in the axial direction, the axial direction denoting the direction substantially perpendicular to the housing base and substantially parallel to the housing wall.

The contouring has a positive effect on the damping in the axial direction and also a constant stiffness profile. However, there are also limits to the height differences between elevations and depressions, since at high values unequal states of stress arise in the damping element, in particular when the damping element is present in a prestressed state in the ready-assembled damper bearing. It has been shown, inter alia in driving trials, that values in the abovementioned preferred ranges of the height difference fulfill both the necessary characteristics with regard to the damping behavior and also bring about good noise damping. Height differences in the ranges mentioned are advantageous with respect to the service life of the damping elements, too.

The height differences between adjacent elevations and depressions may have different magnitudes, both as seen in the radial direction and as seen in the circumferential direction. The direction details are explained on the basis of the example of a cylindrical housing having a circular cross section, in which the axis runs through the mid-point of the bore in the housing base. The radial direction denotes in this case the direction which points outwardly toward the housing wall perpendicularly to the axis from the mid-point thereof. The circumferential direction is understood in this case first of all to mean the circular line which is formed by the transition of the housing base to the housing rim. Furthermore, the circumferential direction is understood to mean any circular line which is concentric with the axis. In the case of cylindrical housings having a non-circular cross section, the expressions “radial direction” and “circumferential direction” should be understood to be analogous.

In a preferred embodiment, the height differences between adjacent elevations and depressions have equal magnitudes in the circumferential direction. In a further preferred embodiment, these height differences also have equal magnitudes in every radial direction.

Preferably, the contouring is formed in an undulating manner. The undulation in which the elevations are rounded has an advantageous effect in that the material is protected by the absence of contour peaks. Preferably, the undulation peaks and undulation troughs are arranged uniformly in the circumferential direction, as a result of which equal distribution of stress is favored in the damping element. In one embodiment, the undulation peaks and undulation troughs are configured in a trapezoidal manner in the circumferential direction, with the transitions being rounded in order to reduce stress peaks in the material of the damping element. Embodiments in which the undulation peaks and undulation troughs are configured in a sinusoidal manner in the circumferential direction are preferred. In this case, the term “sinusoidal” should not be understood in the strict mathematical sense, but describes undulations which are similar to a sine wave. What is essential here is the smooth transition from elevations to depressions in the undulation.

It has been shown that, in the case of a constant diameter of the damping element, the stress in the material of the damping element increases as the number of undulation peaks and undulation troughs rises, since the angle between undulation peaks and undulation troughs becomes steeper. Local stress peaks with a sign change are then close together, this having a negative effect on the service life of the damping element. Advantageously, at least four undulation peaks and undulation troughs are present on the inner surface in question. Contouring having five, six, seven, eight, nine, ten, eleven or twelve undulation peaks and undulation troughs is particularly preferred, in particular contouring having six to ten undulation troughs and undulation peaks.

Design parameters, such as the number of elevations and depressions, the maximum height difference between them, the diameter of the damping element, influence the damping properties of the damper bearing. It has been found that particularly favorable damping properties arise in damping elements based on cellular polyisocyanate-polyaddition products, when the quotient of the outside diameter of the contouring on the one hand and the number of elevations and the maximum height difference on the other hand has a value of between three and six, in particular between four and five.

In preferred configurations, the housing and the housing base of the damper bearing are produced from metal or plastic. The cover can likewise be produced from metal or plastic. Suitable metals are for example aluminum alloys or steel alloys, aluminum being preferred, in particular aluminum EN AC-44300. Preferred plastics for producing the damper bearing are polyoxymethylene or polyamide, which are particularly preferably fiber reinforced, in particular with glass fibers. It is advantageous for the coefficient of friction between the materials of the housing and of the cover, on the one hand, and the material of the damping element, on the other hand, to be selected to be as low as possible, in order to favor sliding of the damping element on the contouring. The contouring of the housing base and/or cover can be produced during the production of these components, for example by way of corresponding negative contouring in a mold or by means of shaping by forging, pressing or deep drawing.

In a preferred embodiment, the housing and the housing base of the damper bearing according to the invention are formed in one piece. The cover can be fastened on the housing in a known manner, for example by a form-fitting or materially integral connection. Preference is given to rolling, plugging, screwing or welding.

In a further preferred embodiment, the cover of the housing is formed as part of the bodywork of a vehicle. In this embodiment, the contouring is advantageously produced by deep drawing or welding on. The housing is preferably fastened to the cover by known methods such as screwing.

The damper bearing according to the invention is suitable for accommodating in its housing at least one damping element, which can be fixed in the housing by way of the cover. The damping element can be in one or more parts and be based on known materials such as rubber or polyisocyanate-polyaddition products.

In a preferred embodiment, the damping element is based on elastomers on the basis of cellular polyisocyanate-polyaddition products, particularly preferably on the basis of cellular polyurethane elastomers, which may comprise polyurea structures. Cellular means that the cells preferably have a diameter of from 0.01 mm to 0.5 mm, particularly preferably from 0.01 mm to 0.15 mm.

Particularly preferably, the polyisocyanate-polyaddition products have at least one of the following material properties: a density to DIN EN ISO 845 of between 270 and 900 kg/m³, a tensile strength to DIN EN ISO 1798 of ≧2.0 N/mm², an elongation at break to DIN EN ISO 1798 of ≧200% or a tear propagation resistance to DIN ISO 34-1 B (b) of ≧8 N/mm. In further preferred embodiments, a polyisocyanate-polyaddition product has two, and more preferably three of these material properties, and particularly preferred embodiments have all four of the material properties mentioned.

Elastomers on the basis of polyisocyanate-polyaddition products and the production thereof are well known and extensively described, for example in EP 62 835 A1, EP 36 994 A2, EP 250 969 A1, EP 1 171 515 A1, DE 195 48 770 A1 and DE 195 48 771 A1.

In a further preferred embodiment, the damping element comprises an insert which is suitable for fastening a piston rod of a shock absorber thereon. The insert is advantageously produced from metal, for example steel and/or aluminum. It may also be produced from a hard plastic, for example a fiber-reinforced polyamide. The insert is preferably connected to the damping element in a form-fitting or materially integral manner, for example by casting, vulcanizing or adhesive bonding. Preferably, the insert is rotationally symmetrical and may, for the purpose of rotation prevention, be provided with a suitable contour, for example a notch.

In a preferred embodiment of the invention, the damper bearing and the damping element are matched to one another such that, in the installed state, the distance between the housing base and the cover makes up from 50% to 95% of the height of the damping element, so that the damping element is prestressed. The distance relates in this case to those points of the housing base and the cover that are least far apart. In the case of contouring both of the inner surface of the housing base and of the inner surface of the cover, the distance means the shortest spacing between the peaks of the respective elevations.

Particularly preferably, the prestress is selected such that, after the damping element has been installed in the damper bearing, the damping element is in contact at the undulation troughs with the surface of the housing base and/or cover. The prestress is preferably selected to be greater, the more the damping element is loaded in the axial direction, and is thus moved, when employed in the vehicle. This ensures that, even in the case of high loading, the damping element remains in contact with the surface of the housing base and/or of the cover.

The damping element is preferably produced first of all as a preliminary product, in which a plurality of damping elements are produced in a cohesive manner. The individual damping elements are produced from this preliminary product by cutting, for example by means of a fine jet of water. This procedure enables production of the damping elements which is much more cost-effective than the production of axially contoured damping elements, as are described for example in the Offenlegungsschrift DE 10 2005 009 667 A1.

Producing the contouring in the housing base and/or cover causes no or only very low additional costs compared with housing bases and covers without contouring. Damper bearings according to the invention therefore have a cost advantage over known damper bearings, in which axial contouring is implemented in the damping element. They are also easy to produce, thereby having a positive effect on the reject rate. With regard to the damping properties, such as constant stiffness profile and noise reduction, the damper bearings according to the invention are at least equally as good as the known bearings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 schematically shows an exploded illustration of a preferred embodiment of a damper bearing; and

FIGS. 2-3 show sectional illustrations of a preferred embodiment of a damper bearing according to the invention for use in a production vehicle.

### DETAILED DESCRIPTION

### Example 1

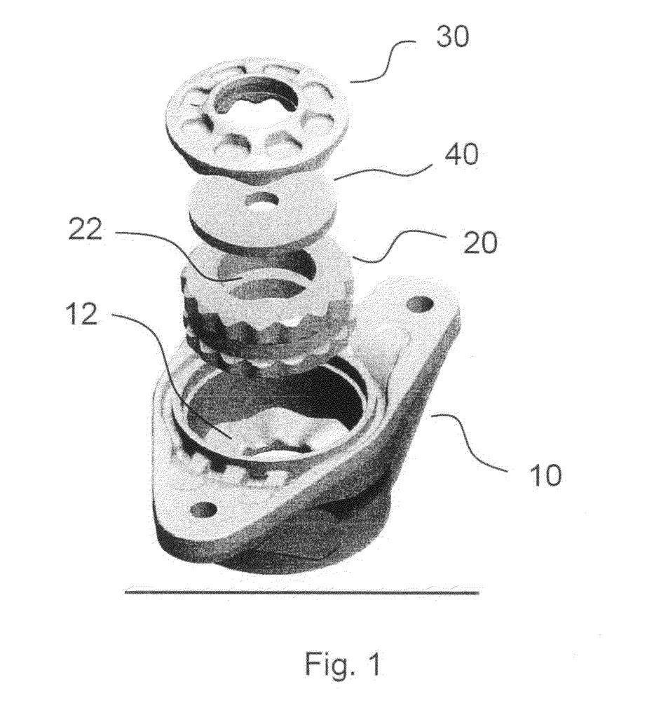

FIG. 1 schematically shows an exploded illustration of a preferred embodiment of a damper bearing according to the invention. A housing 10 has a bore in the middle of the housing base 12. The inner surface of the housing base 12 is provided with eight elevations and eight depressions, which are configured in a sinusoidal manner in the circumferential direction. A damping element 20 on the basis of cellular polyisocyanate-polyaddition products is inserted into the housing. The end faces of the damping element 20 are planar and the radial lateral surface is circumferentially contoured. The maximum outside diameter of the damping element 20 is slightly greater than the inside diameter of the cylindrical housing 10, and so the damping element 20 is slightly prestressed in the radial direction in the installed state.

An insert 40 is inserted into a cutout 22 in the damping element 20. The insert 40 is produced from steel and serves, in the completed and installed state, to fasten the upper end of the piston rod of a shock absorber. The damper bearing is terminated upwardly in the axial direction by a cover 30, which likewise has a central bore. Like the inner surface of the housing base 12, the inner surface of the cover 30 is provided with in each case eight elevations and depressions, which are formed in a sinusoidal manner in the circumferential direction.

### Example 2

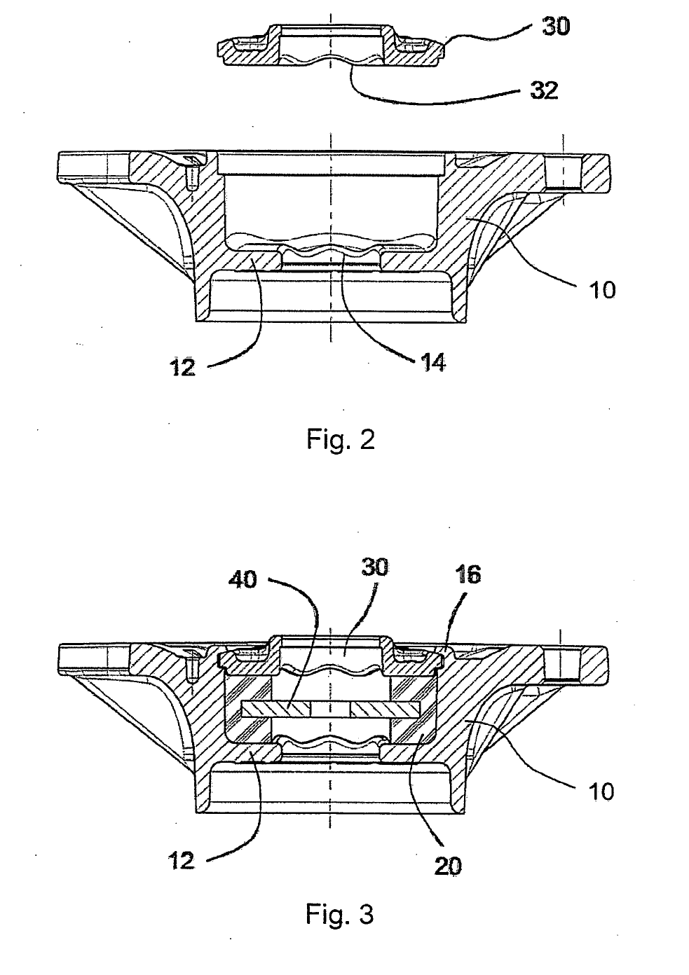

FIG. 2 and FIG. 3 show sectional illustrations of a preferred embodiment of a damper bearing according to the invention for use in a production vehicle. As in the embodiment according to FIG. 1, the damper bearing comprises a housing 10, a cover 30 and a damping element 20 having an insert 40. FIG. 2 illustrates the housing 10 and the cover 30 prior to their assembly. The housing 10 has a bore having a diameter of 26 mm in the middle of the housing base 12. The inner surface of the housing base 12 is provided with contouring 14 having six elevations and six depressions, which are configured in a sinusoidal manner in the circumferential direction. The height difference between the undulation peaks and undulation troughs is 2 mm. The inside diameter of the housing is 56.5 mm at the housing base. Since the contouring extends in the radial direction as far as the housing wall, the outside diameter of the contouring is likewise 56.5 mm. This produces a value of 56.5 mm/(6·2 mm)=4.7 for the quotient of the outside diameter of the contouring on the one hand and the number of elevations and the maximum height difference on the other hand.

The housing is substantially cylindrical with an angle of 91° between the inner surface of the housing base 12 and the housing wall. The inner surface of the cover 30 is likewise provided with contouring 32 having in each case six elevations and depressions, which are formed in a sinusoidal manner in the circumferential direction. In the case of the cover, too, the height difference between the undulation peaks and undulation troughs is 2 mm.

The damping element 20 on the basis of cellular polyisocyanate-polyaddition products has a basic form as is illustrated schematically in FIG. 1. The end faces of the damping element 20 are planar and the radial lateral surface is circumferentially contoured. It has two rows of in each case sixteen elevations, which are distributed uniformly around the circumference. The maximum outside diameter from elevation to elevation is 56.5 mm and thus corresponds to the inside diameter of the housing at the housing base. The minimum outside diameter of the damping element is 52.5 mm, the inside diameter is 32 mm and the height is 24.5 mm. Fitted in a cutout in the damping element 20 is an insert 40, which has an outside diameter of 48 mm and a height of 4.5 mm.

FIG. 3 illustrates the damper bearing in the completed state. The damping element 20 rests by way of its end faces against the contouring of the housing base 12 and the contouring of the cover 30. The cover is fastened to the housing 10 by a flange 16. The distance between the undulation troughs of the housing base and the cover is about 21 mm, and so the damping element 20 is prestressed in the axial direction. The effect of this axial prestress is that the damping element expands in the radial direction, and so it is also slightly prestressed in the radial direction. The effect of this prestress is that the damping element is always in contact with the housing base and the cover even in the event of loading in the vehicle. This ensures a constant stiffness profile, which has a positive effect on the damping properties of the damper bearing.

1. A golf putter grip, comprising:
a top cap portion, a bottom open end, and a main tubular body extended between the top cap portion and the bottom open end;
wherein the top cap portion has a top end;
wherein said main tubular body has:
a cavity to receive a golf shaft;
a non-circular cross-section being symmetrical and remaining similar throughout an axial length of said main tubular body, where said non-circular cross-section has a width dimension defined to be the maximum dimension between the outmost edges of said non-circular cross-section and perpendicularly along the axial length of said main tubular body, and said width dimension is within a range from 44.45 mm to 29.63 mm; and
a flat front area having a width dimension in a range from 42.45 mm to 20 mm and being perpendicularly along and throughout the axial length of said main tubular body, where said non-circular cross-section has a depth dimension defined to be the maximum dimension perpendicularly from the flat front area to a bottom of said non-circular cross-section along the axial length of said main tubular body, and said depth dimension is in a range from 44.45 mm to 23.09 mm;
wherein said main tubular body is reversely tapered from the top cap portion towards the bottom open end;
wherein said non-circular cross-section includes a first non-circular cross-section and a second non-circular cross-section; the first non-circular cross-section has a depth dimension that is the longest depth dimension in said main tubular body and is towards a position within one inch (25.4 mm) from the bottom open end; the second non-circular cross-section has a depth dimension that is the shortest depth dimension in said main tubular body and is towards a position within one inch (25.4 mm) from the top end;
wherein the depth dimension of the first non-circular cross-section is longer than the depth dimension of the second non-circular cross-section in a ratio of 1.12:1 to 1.75:1.

2. The golf putter grip as claimed in claim 1, wherein the overall length of the golf putter grip is in a range from 7 inches (177.8 mm) to 11.38 inches (289.05 mm).

3. The golf putter grip as claimed in claim 1, wherein the flat front area has a width dimension in a range from 42.45 mm to 25.63 mm.

4. The golf putter grip as claimed in claim 1, wherein the flat front area is in a rectangular shape for golf players to place two thumbs side by side on the flat front area comfortably.

5. The golf putter grip as claimed in claim 4, wherein the flat front area is planar, whereby it is able to enhance the golf putter grip being installed properly with the flat front area perpendicularly to a club head face of a golf putter.

6. The golf putter grip as claimed in claim 1, wherein said non-circular cross-section is in a flat-topped arch shape for golf players to cup two hands together at the same height and place two thumbs side by side on the flat front area to hold the golf putter grip comfortably.

7. The golf putter grip as claimed in claim 1, wherein said main tubular body has a downward body connected with the flat front area by means of a pair of curves forming smoothly rounded shoulders along the axial length of said main tubular body.

8. The golf putter grip as claimed in claim 1, further comprising a hollow lower portion extended and tapered from said main tubular body to the bottom open end.

9. A golf putter grip, comprising:
a top cap portion, a bottom open end, and a main tubular body extended between the top cap portion and the bottom open end;
wherein the top cap portion has a top end;
wherein said main tubular body has:
a cavity to receive a golf shaft;
a non-circular cross-section being symmetrical and remaining similar throughout an axial length of said main tubular body; where said non-circular cross-section has a width dimension defined to be the maximum dimension between the outmost edges of said non-circular cross-section and perpendicularly along the axial length of said main tubular body, and said width dimension is in a range from 44.45 mm to 33 mm; and
a flat front area having a width dimension in a range from 42.45 mm to 23 mm and being perpendicularly along and throughout the axial length of said main tubular body, where said non-circular cross-section has a depth dimension defined to be the maximum dimension perpendicularly from the flat front area to a bottom of said non-circular cross-section along the axial length of said main tubular body, and said depth dimension is in a range from 40.41 mm to 23.09 mm;
wherein said main tubular body is reversely tapered from the top cap portion towards the bottom open end;
wherein said non-circular cross-section's width dimension is longer than said non-circular cross-section's depth dimension in a ratio of 1.1:1 to 1.93:1;
wherein said non-circular cross-section includes a first non-circular cross-section and a second non-circular cross-section; the first non-circular cross-section has a depth dimension that is the longest depth dimension in said main tubular body and is towards a position within one inch (25.4 mm) from the bottom open end; the second non-circular cross-section has a depth dimension that is the shortest depth dimension in said main tubular body and is towards a position within one inch (25.4 mm) from the top end;
wherein the depth dimension of the first non-circular cross-section is longer than the depth dimension of the second non-circular cross-section in a ratio of 1.12:1 to 1.75:1.

10. The golf putter grip as claimed in claim 9, wherein the overall length of the golf putter grip is in a range from 7 inches (177.8 mm) to 11.38 inches (289.05 mm).

11. The golf putter grip as claimed in claim 9, wherein the flat front area has a width dimension in a range from 42.45 mm to 29 mm.

12. The golf putter grip as claimed in claim 9, wherein the flat front area is in a rectangular shape for golf players to place two thumbs side by side on the flat front area comfortably.

13. The golf putter grip as claimed in claim 12, wherein the flat front area is planar, whereby it is able to enhance the golf putter grip being installed properly with the flat front area perpendicularly to a club head face of a golf putter.

14. The golf putter grip as claimed in claim 9, wherein said non-circular cross-section is in a flat-topped arch shape for golf players to cup two hands together at the same height and place two thumbs side by side on the flat front area to hold the golf putter grip comfortably.

15. The golf putter grip as claimed in claim 9, wherein the depth dimension of the first non-circular cross-section is in a range from 40.41 mm to 30 mm, and the depth dimension of the second non-circular cross-section is in a range from 36.08 mm to 23.09 mm, whereby the golf putter grip's main tubular body is reversely tapered and its reverse taper is sufficient to some degrees to lessen the gripping pressure so as to make the gripping comfortable for golf players.

16. The golf putter grip as claimed in claim 9, wherein said main tubular body has a downward body connected with the flat front area by means of a pair of curves forming smoothly rounded shoulders along the axial length of said main tubular body.

17. The golf putter grip as claimed in claim 9, further comprising a hollow lower portion extended and tapered from said main tubular body to the bottom open end.

18. A golf putter grip, comprising:
a top cap portion, a bottom open end, and a main tubular body extended between the top cap portion and the bottom open end;
wherein the top cap portion has a top end;
wherein said main tubular body has:
a cavity to receive a golf shaft;
a non-circular cross-section being symmetrical and remaining similar throughout an axial length of said main tubular body, where the non-circular cross-section has a width dimension defined to be the maximum dimension between the outmost edges of said non-circular cross-section and perpendicularly along the axial length of said main tubular body, and said width dimension is in a range from 42.45 mm to 29.63 mm; and
a flat front area having a width dimension being in a range from 40.45 mm to 20 mm and being perpendicularly along and throughout the axial length of said main tubular body, where said non-circular cross-section has a depth dimension defined to be the maximum dimension perpendicularly from the flat front area to a bottom of said non-circular cross-section along the axial length of said main tubular body, and said depth dimension is in a range from 44.45 mm to 25.4 mm;
wherein said main tubular body is reversely tapered from the top cap portion towards the bottom open end;
wherein said non-circular cross-section includes a first non-circular cross-section and a second non-circular cross-section; the first noncircular cross-section has a depth dimension that is the longest depth dimension in said main tubular body and is towards a position within one inch (25.4 mm) from the bottom open end; the second non-circular cross-section has a depth dimension that is the shortest depth dimension in said main tubular body and is towards a position within one inch (25.4 mm) from the top end;
wherein the depth dimension of the first non-circular cross-section is longer than said non-circular cross-section's width dimension in a ratio of 1.01:1 to 1.5:1;
wherein the depth dimension of the first non-circular cross-section is longer than the depth dimension of the second non-circular cross-section in a ratio of 1.12:1 to 1.75:1.

19. The golf putter grip as claimed in claim 18, wherein the overall length of the golf putter grip is in a range from 7 inches (177.8 mm) to 11.38 inches (289.05 mm).

20. The golf putter grip as claimed in claim 18, wherein the flat front area has a width dimension in a range from 40.45 mm to 25.63 mm.

21. The golf putter grip as claimed in claim 18, wherein the depth dimension of the first non-circular cross-section is equal to said non-circular cross-section's width dimension.

22. The golf putter grip as claimed in claim 18, wherein the flat front area is in a rectangular shape for golf players to place two thumbs side by side on the flat front area comfortably.

23. The golf putter grip as claimed in claim 22, wherein the flat front area is planar, whereby it is able to enhance the golf putter grip being installed properly with the flat front area perpendicularly to a club head face of a golf putter.

24. The golf putter grip as claimed in claim 18, wherein said non-circular cross-section is in a flat-topped arch shape for golf players to cup two hands together at the same height and place two thumbs side by side on the flat front area to hold the golf putter grip comfortably.

25. The golf putter grip as claimed in claim 18, wherein the depth dimension of the first non-circular cross-section is in a range of 44.45 mm to 33 mm, and the depth dimension of the second non-circular cross-section is in a range of 39.69 mm to 25.4 mm, whereby the golf putter grip's main tubular body is reversely tapered and its reverse taper is sufficient to some degrees to lessen the gripping pressure so as to make the gripping comfortable for golf players.

26. The golf putter grip as claimed in claim 18, wherein said main tubular body has a downward body connected with the flat front area by means of a pair of curves forming smoothly rounded shoulders along the axial length of said main tubular body.

27. The golf putter grip as claimed in claim 18, further comprising a hollow lower portion extended and tapered from said main tubular body to the bottom open end.
